(19) United States
(12) Patent Application Publication
(10) Pub. No.: US 2002/0163913 A1
(43) Pub. Date: Nov. 7, 2002

(54) Pointer management and content matching packet classification

(76) Inventor: Jintae Oh, St. Louis, MO (US)

Correspondence Address: THOMPSON COBURN, LLP, ONE FIRSTAR PLAZA, SUITE 3500, ST LOUIS, MO, 63101, US

(21) Appl. No.: 09/850,881

(22) Filed: May 7, 2001

(51) Int. Cl. H04L 12/56

(52) U.S. Cl. 370/392

(57) ABSTRACT

The present invention performs the series of table lookups in a radically different way than conventional systems. Specifically, the present invention performs the first table lookup conventionally to match a table entry with header information (say a first byte of header information), and assigns a first pointer to the matching first table lookup entry. For a byte, the first table lookup has 2⁸ entries (256 entries). Then, departing from conventional systems, the present invention provides additional memory to the first pointer. The second byte of header information is stored in memory, the significant bit information of the second byte is stored in memory, and a logic operator (“=” or “<”) is stored in memory. The second table lookup has only two entries, true or false. The correct entry is matched with the information that has been stored in memory with the first pointer, and a second pointer is established. Again, with the second pointer, additional memory is allocated to store the third byte of header information, the significant bit information of the third byte, and a logic operator (“=” or “<”). This process is repeated for all of the header information.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

1. Field of the Invention

This invention relates generally to the classification of information packets such as those transmitted over the Internet and, more particularly, to a faster way of classifying and identifying packets.

2. Related Art

Layer 3 and Layer 4 packet header information includes source Internet protocol address (“source IP address”), source port number, destination Internet protocol address (“destination IP address”), and destination port number. For packets to be switched over the Internet, the packet header information must be read, the packet must be classified, and then the packet is switched.

The prior art uses lookup tables to assist in classifying packets in accordance with the packet header information. For example, the destination IP address may consist of two bytes. For each byte a lookup table exists. The specific value of the byte is matched with a correspondingly exact value in the lookup table. Because the possibilities for one byte range from 00000000 to 11111111, there are 2⁸ entries (256 entries) in a given lookup table for each byte. If the packet header consists of just 10 bytes of words, then there must be 10 lookup tables consisting of 2,560 entries in the aggregate.

Clearly, packet classification requires a large amount of memory to contain all of the table entries required for packet lookup tables. Thus, SDRAM-type memory is used to store lookup tables. At the present time, the fastest SDRAM operates at approximately 266 MHz. It is believed that the fastest lookup tables are able to operate theoretically at approximately 7 clock cycles per table. Thus, if it is required that 10 bytes in the packet header be classified prior to switching, then at least 70 clock cycles will be required before the packet can be completely classified, with additional clock cycles being required for switching.

There is a need in the art to provide faster packet classification.

### SUMMARY OF THE INVENTION

It is in view of the above problems that the present invention was developed. The invention is a method of packet classification that can be used for switching or can be used for security intrusion detection. As in any packet classification system, a system receives packets, reads the packet header information, the Layer 3 and Layer 4 information, and performs a series of table lookups to classify the packet. However, the present invention performs the series of table lookups in a radically different way than conventional systems. Specifically, the present invention performs the first table lookup conventionally to match a table entry with header information (say a first byte of header information), and assigns a first pointer to the matching first table lookup entry. For a byte, the first table lookup has 2⁸ entries (256 entries). Then, departing from conventional systems, the present invention provides additional memory to the first pointer. The second byte of header information is stored in memory, the significant bit information of the second byte is stored in memory, and a logic operator (“=” or “<”) is stored in memory. The second table lookup has only two entries, true or false. The correct entry is matched with the information that has been stored in memory with the first pointer, and a second pointer is established. Again, with the second pointer, additional memory is allocated to store the third byte of header information, the significant bit information of the third byte, and a logic operator (“=” or “<”). This process is repeated for all of the header information.

It should be noted that if there are no significant bits in a byte, then the table lookup will have only one entry.

With the understanding of how the present invention works, the present invention can be used to classify packets at a rate of 1 clock cycle per table. With the reduced number of entries per table, less memory is required and faster SRAM can be used that operates at 300 MHz. Thus, in stark contrast to conventional packet classification and lookup systems, a dramatic reduction in the number of clock cycles (from 7 to 1) is achieved, and different kind of memory operating at a faster rate (SRAM at 300 MHz vs. SDRAM at 266 MHz) can be employed.

In addition, due to the improvements in packet lookup speed, the present invention may also be applied to intrusion detection/computer security. Specifically, the packet headers and the contents of the packets may be examined in real-time to assess security threats prior to switching any potential offending packets.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates table lookups in a conventional system;

FIG. 2 illustrates table lookups, pointer assignment, memory allocation, next byte storage, significant bit storage, and logic operator of the present invention; and

FIG. 3 illustrates a comparison of the number of table entries of various packet classification and table lookup systems.

### DETAILED DESCRIPTION OF THE PREFERRED EMBODIMENTS

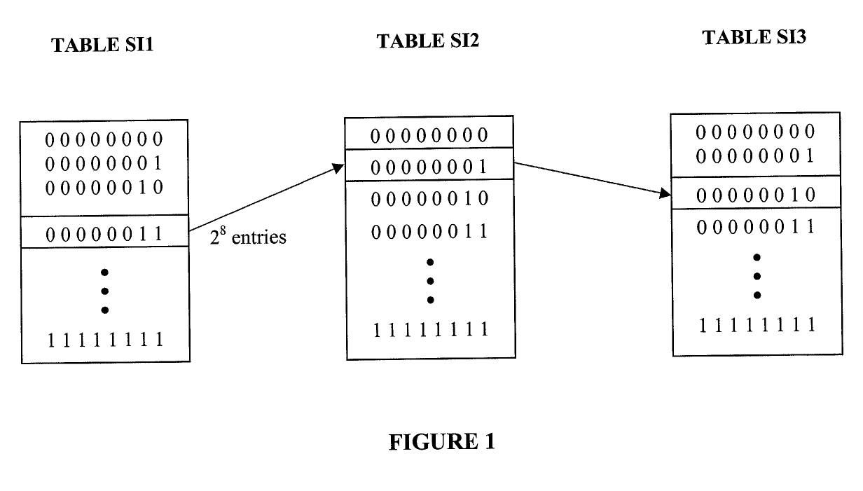

Referring to the accompanying drawings in which like reference numbers indicate like elements, FIG. 1 illustrates table lookups in a conventional system.

A packet header contains information such as source IP address, source port number, destination IP address and destination port number. The source IP address can be in the form of “A.B.C.D”. For example, a source IP address could be 216.59.87.31. This address is transmitted as a series of 8-bit words. Each word in the series is matched with a lookup table and is matched with an entry in the lookup table in order to assist in classifying the packet. A further explanation of this, table lookups, classification, as well as a Best Matching Policy is set forth in co-pending U.S. patent application Ser. No. 09/668,651 entitled Best Matching Policy Lookup Using Classification Engine Matrix, filed on Sep. 22, 2000, which is hereby incorporated by reference in its entirety.

Because each table has 2⁸ entries, a significant amount of memory is required to store the tables. If a switch is operating at a rate of 2.5 Gigabits per second, there can be 312.5 million words per minute streaming into the switch. Each of the 312.5 million words require 2⁸ entries for table lookup. Thus, a significant amount of memory is required. SDRAM operating at 266 MHz is generally the memory of choice to meet these memory capacity demands. The best speeds so far available require approximately 7 clock cycles per table lookup. For each 10 serial table lookups, 70 clock cycles are required.

For example, in FIG. 1, the first table for matching the first word of Source IP address is Table SI1. Because there are 8 bits in each word, and each bit can be a “0” or a “1”, the table has 2⁸ entries. The first word of the source IP header is 00000011, so the corresponding entry in the table is located and matched with the header value, and a pointer is assigned to point from the entry to the second table, Table SI2. Again, the second source IP header word value is located and matched with the corresponding entry in Table SI2. A second pointer is assigned to point to Table SI3, where again the corresponding entry in the table is located and matched with the header value.

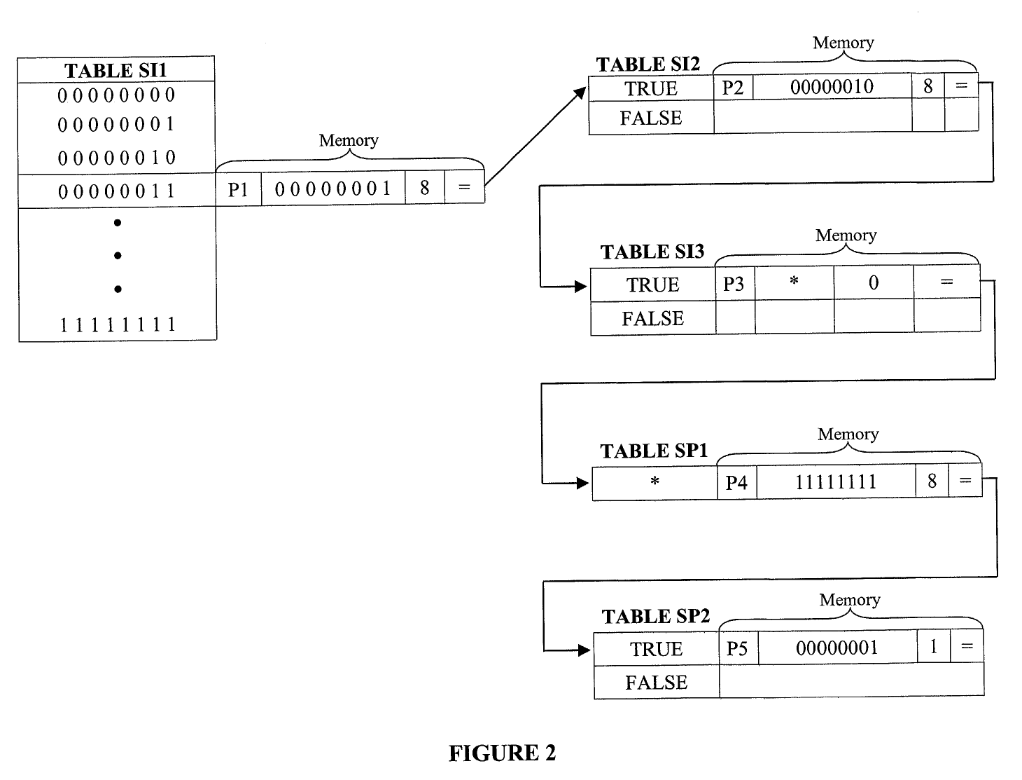

FIG. 2 illustrates table lookups, pointer assignment, memory allocation, next byte storage, significant bit storage, and logic operator of the present invention. As seen in FIG. 2, the present invention performs the first table lookup conventionally to match a table entry with header information (say a first byte of header information of a source IP address), and assigns a first pointer P1 to the matching first Table SI1 lookup entry. For a byte, as seen in Table SI1, there are 2⁸ entries (256 entries). Then, in a conceptual departure from conventional lookup and classification systems, additional memory is provided to the first pointer P1. The second byte of header information is stored in P1 memory, the significant bit information of the second byte is stored in P1 memory, and a logic operator (“=” or “<”)is stored in P1 memory.

As further seen in FIG. 2, the second table lookup, Table SI2, has only two entries true or false. The correct entry is “true” because it is true that the second byte has 8 significant bits and that the byte in memory is equal to the second byte. Once the correct entry is determined, a second pointer P2 is established. Again, with second pointer P2, additional memory is allocated to store the third byte of header information, the significant bit information of the third byte, and a logic operator (“=” or “<”). This process is repeated for all of the source IP header information.

As further seen in FIG. 2, when the next byte does not refer to source IP header, here the next byte refers to source port number, the same process is still repeated. It should be noted that if there are no significant bits in a byte, then the next table lookup will have only one entry. Thus, a wild card “*” is shown in the memory allocated to third pointer P3, and “0” is shown as the significant bit. The next table lookup, Table SP1, has only one entry. Fourth pointer P4 is established, and the byte information of the fifth byte is copied into memory, together with significant bit information, and a logic operator.

As next shown in FIG. 2, Table SP2 has only two entries, true or false.

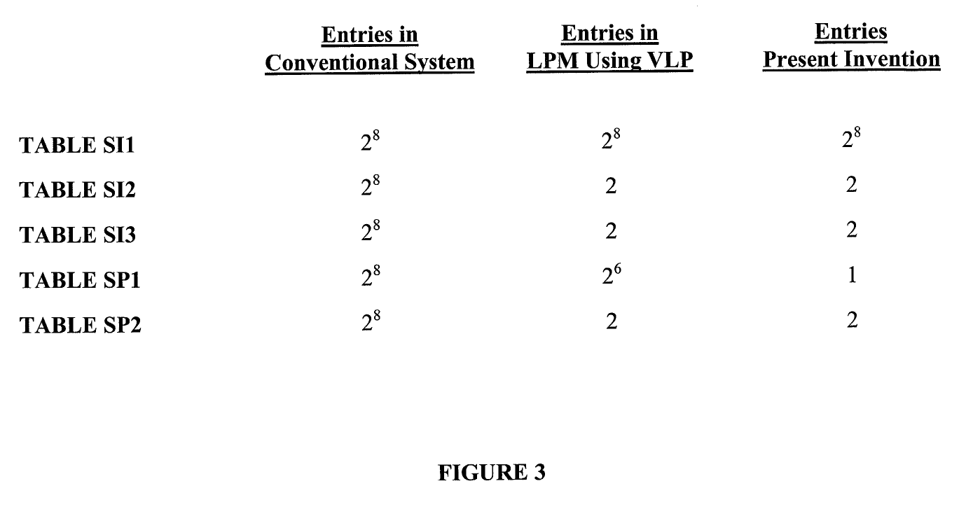

It is pointed out that the present invention is also an improvement over U.S. patent application Ser. No. 09/671,808 entitled Longest Prefix Matching Using Variable Length Pointer (“LPM Using VLP”) filed Sep. 22, 2000, which is hereby incorporated by reference in its entirety. A comparison of the number of table entries of various approaches is shown in FIG. 3.

With the understanding of how the present invention works, the present invention can be used to classify packets at a rate of 1 clock cycle per table. With the reduced number of entries per table, less memory is required and faster SRAM can be used that operates at 300 MHz. Thus, in stark contrast to conventional packet classification and lookup systems, a dramatic reduction in the number of clock cycles (from 7 to 1) is achieved, and different kind of memory operating at a faster rate (SRAM at 300 MHz vs. SDRAM at 266 MHz) can be employed.

Intrusion Detection

As mentioned earlier, due to the improvements in packet lookup speed, the present invention may also be applied to intrusion detection/computer security at two different layers. First, the packet headers can be examined for security threats. Specifically, security information can be maintained regarding various source port numbers, source IP addresses, and destination port numbers. It can be recognized that many computer systems have a “back door” through which access can be achieved. This remote “back door” access can be achieved, for example, by sending commands to specific back door destination port numbers. Alternatively and similarly, source IP address or source port number may be recognized as an unreliable point of origination. In either case, this packet information can be stored in lookup tables, and matched in accordance with the methods set fort above.

At the second level of intrusion detection, the contents of the packets may be examined in real-time to assess security threats prior to switching any potential offending packets. Co-pending U.S. patent application Ser. No. 60/266,600 entitled Intrusion Detection System filed on Feb. 5, 2001 describes an intrusion detection system that utilizes content pre-filtering to reduce the effective data transmission rate of content that must be inspected. This co-pending patent application is hereby incorporated by reference in its entirety. The present invention complements the pre-filtering.

Specifically, the present invention may be used to examine the content that has been pre-filtered in co-pending patent application Ser. No. 60/266,600. Various content is digitally transmitted using ASCII format. This content includes command language and phrases whose digital byte equivalent is stored lookup tables. Then, in accordance with the present invention, table lookups are performed to see whether there is a table entry match with the content. If there is a match between content and a table lookup entry, then the packet(s) may be dropped, not switched, or forwarded to a network manager for further handling and action. Because this occurs at a rate of one clock cycle per table lookup (just as with packet classification), the system achieves a wire-speed content check.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method of handling information packets comprising:
receiving an information packet;
reading a plurality of bytes of information in the packet relating to packet source or packet destination;
matching the first byte of information to a first matching entry in a first lookup table;
assigning a first pointer to said first matching entry;
storing in memory a second byte of information and associating said second byte of information with said first pointer;
storing in memory a first logic operator associated with said second byte of information and associating said first logic operator with both said first pointer and said second byte of information.

2. A method of handling information packets according to claim 1, wherein the information relating to packet source includes source Internet Protocol address.

3. A method of handling information packets according to claim 1, wherein the information relating to packet source includes source port number

4. A method of handling information packets according to claim 1, wherein the information relating to packet destination includes destination Internet Protocol address.

5. A method of handling information packets according to claim 1, wherein the information relating to packet destination includes destination port number.

6. A method of handling information packets according to claim 1, wherein the information relating to packet source or packet destination is Layer 3 and Layer 4 information.

7. A method of handling information packets according to claim 1, further comprising:
storing in memory information about significant bit length of the second byte of information and associating said significant bit length information with said first pointer, said second byte of information, and said logic operator.

8. A method of handling information packets according to claim 7, further comprising:
matching the information stored in memory in association with said first pointer, with a second matching entry in a second table lookup.

9. A method of handling information packets according to claim 8, further comprising:
assigning a second pointer to said second matching entry;
storing in memory a third byte of information and associating said third byte of information with said second pointer;
storing in memory a second logic operator associated with said third byte of information and associating said second logic operator with both said second pointer and said third byte of information; and
storing in memory information about significant bit length of the third byte of information and associating said significant bit length information with said second pointer, said third byte of information, and said second logic operator.

10. A method of handling information packets according to claim 8, wherein said second lookup table comprises a true-false table.

11. A method of handling information packets comprising:
providing a first lookup table having 2⁸ entries for a first byte of information;
when the second byte of information has significant bits of information, providing a second lookup table having only 2 entries
when the second byte of information has no significant bits of information, providing a second lookup table having 1 entry;
linking said first lookup table to said second lookup table using a pointer.
